(19) United States
(12) Patent Application Publication
(10) Pub. No.: US 2009/0051312 A1
(43) Pub. Date: Feb. 26, 2009

(54) BATTERY CHARGER

(76) Inventors: Rodolphe J. Simon, Dexter, ME (US); Peter Seamans, St. Albans, ME (US); Barry Evans, Bangor, ME (US)

Correspondence Address: RODOLPHE J.SIMON, 100 GOFF ROAD, DEXTER, ME, 04930, US

(21) Appl. No.: 11/844,051

(22) Filed: Aug. 23, 2007

(51) Int. Cl. H02J 7/00

(52) U.S. Cl. 320/103

(57) ABSTRACT

A battery charger for wirelessly providing additional operating time for a cell phone with a depleted battery. The battery charger has a charging unit incorporated into a case. The charging unit has an external port, a cell phone charging port, and a rechargeable battery. A cell phone with a depleted battery is placed inside the case and plugged into the cell phone charging port. The rechargeable battery of the charging unit recharges the cell phone battery, without requiring that either the battery charger or the cell phone be plugged into an external power source. An ON/OFF switch allows the user to enable/disable recharging. A status indicator light indicates the status of the battery charger. When the battery in the charging unit is depleted, the user plugs the charger into a standard external power source to recharge.

### BACKGROUND INFORMATION

1. Field of the Invention

The invention relates to the field of battery chargers. More particularly, the invention relates to chargers for cell phones.

2. Description of the Prior Art

Cell phones are no longer used primarily to make short or emergency phone calls. People use cell phones today as their primary means of communication, as personal organizers, and as storage devices for electronic information. Many cell phones today are also capable of playing music and movies, taking pictures, surfing the Internet, and sending and receiving email and text messages. The evolution from a simple emergency phone to a multiuse personal assistant device requires a correspondingly increased amount of power. The average cell phone provides, on average, 2-12 hours of operating time before the cell phone battery needs to be recharged. The amount of time depends on the type of tasks the phone is required to perform. Tasks, such as surfing the Internet, sending email, or watching a movie, require substantially more power than simple aural communication.

The cell phone is powered by a rechargeable battery, which is recharged with a cell phone charger. Although cell phones have evolved into more sophisticated devices, battery chargers have not. The result is that cell phone batteries frequently run out of power and require frequent recharging. A battery that is depleted or is in danger of depletion is problematic for someone waiting for an email, or needing to make or finish an important call. Recharging a cell phone using a standard battery charger, which is a corded device, requires that the charger either be plugged into an external power source, such as a standard household outlet that supplies 110 VAC or a standard automobile charger that supplies 12 VDC. The charging process imposes several conditions: first, the user must be at a place where there is an external power source. This can pose a problem, depending on the location of the user, because it is hard to find a publicly accessible power source at some places, such as a campground or a beach. Second, the user generally needs to carry two separate chargers, one for the standard household outlet and one for the automobile charger, because universal chargers that plug alternatively into the standard wall outlet and the automobile charger are not generally available. Once a power source for charging the battery has been found, the user, if he or she desires to use the cell phone while it is charging, is then confined to the immediate surroundings of the power source. This may be inconvenient. A further disadvantage with charging the cell phone with the conventional corded cell phone charger is that cell phone charger cords are often short, often causing the user to sit on the floor in a public place or conduct a call with little privacy, because the power source is located in a populated area.

Emergency battery chargers are known and can be used to immediately charge a cell phone without an external power source. Such emergency chargers, however, are either disposable and expensive, or require direct sunlight for a charge. Many of these emergency battery chargers provide power for only a few minutes of talk time or have a lengthy charging time, such as 45 minutes, before gaining enough power to talk more than just a few minutes. Other cell phone chargers require the use of lithium AA batteries to transfer power from the charger to the phone. These chargers are typically for one-time use only before the expensive lithium batteries need to be replaced. Using the cell phone for tasks other than talking, such as watching a movie, consumes more power and, therefore, decreases the small amount of energy gained from one of these emergency chargers. In other words, emergency chargers are truly for emergency purposes only and are not ideal for extending the operation time of an electronic device beyond a short amount of time.

What is needed, therefore, is a portable, cordless battery charger that immediately charges a cell phone, without requiring immediate access to an external power source. What is further needed is such a battery charger that provides a substantial amount of additional operating time, before having to plug the cell phone into the external power source.

### BRIEF SUMMARY OF THE INVENTION

The invention is a battery charger that provides additional operating time for an electronic device that has a depleted battery, without connecting the electronic device to an external power source via a corded charging device. The battery charger according to the invention comprises a charging unit that is incorporated into a cell phone holder. The phone holder is adapted for a particular type or model of cell phone and may be a familiar style of a case, such as a clip-on holder, leather case, or rigid shell. The charging unit is incorporated into a wall of the phone holder. A cell phone port extends from the charging unit into the storage area of the phone holder, such that, when the cell phone is inserted into the phone holder, the cell phone port couples with the cell phone charging connector. Depending on the model of cell phone, the charging unit may be incorporated into the bottom wall of the phone holder, into a side wall, into a top wall, etc. The battery charger according to the invention provides a cell phone with an additional 5 to 9 hours of use, without requiring the phone to be plugged into an external power source, such as the standard household outlet or the car charger.

The battery charger has an external charging connector, a cell phone or device charger port, a switch, a rechargeable battery, and charging circuitry. The ports are of the types typically used for cell phones. Optionally, an indicator light may be provided on the case, to indicate the status of the battery charger, such as, charging, fully charged, in need of charging. The charging unit charges the battery in the cell phone only when the switch is set to ON. The battery in the charging unit is a standard rechargeable battery that is typically used in cell phones and other communication devices, such as, for example, a 6-volt battery. The battery may also be replaceable. The external charging port is used to couple the charging unit via a corded charging device to a standard external power source, in order to recharge the charging unit battery.

The battery charger according to the invention enables the user to continue using a cell phone with a depleted cell phone battery for an additional five to nine hours of operating time, without having to connect the cell phone to an external power source. The amount of time provided by the charging unit depends on the particular type and model of cell phone or device and the types of tasks performed with the device.

### BRIEF DESCRIPTION OF THE DRAWINGS

The present invention is described with reference to the accompanying drawings. In the drawings, like reference numbers indicate identical or functionally similar elements. The drawings are not necessarily to scale.

FIG. 1 is a cross-sectional frontal view of a battery charger according to the invention.

FIG. 2 is a schematic diagram of the charging unit.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

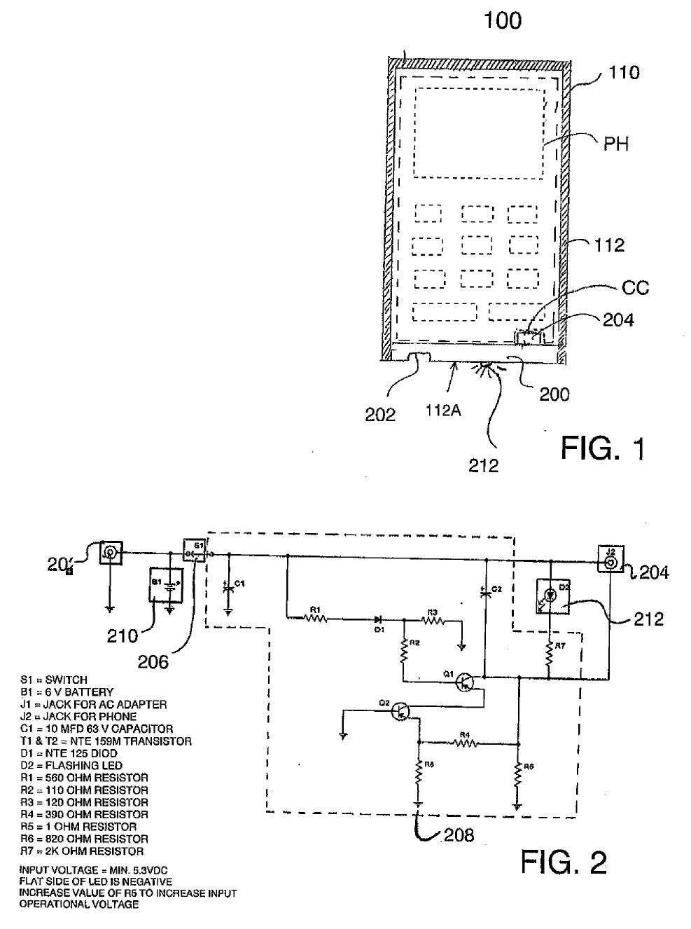

FIG. 1 is a battery charger 100 for electronic devices, which have rechargeable batteries, such as cell phones or IPODs. Reference shall be made hereinafter to a cell phone PH and a battery charger 100, but it is understood that the charger 100 may be adapted for use with other types of electronic communication devices. The cell phone PH is shown only schematically in dashed lines. The battery charger 100 comprises a charging unit 200 that is incorporated into a case 110. The case 110 shown in FIG. 1 is generally representative of cases or holders for small handheld electronic devices, but with the addition of the charging unit 200. The case 110 has case walls 112 that define a storage area 114. The storage area 114 houses the cell phone or other such electronic device. The charging unit 200 is embedded into one of the walls 112. All cell phones have a charging port CP for receiving a conventional charger. Typically, this charging port CP is located at the bottom, the side, or the top of the cell phone. The location, as well as the dimensions and shape, of the charging port CP varies from model to model, and the charger 100 is adapted to store and charge a cell phone of a particular geometry with a particular charging port CP. In the example shown, the cell phone PH has the charging port CP on the bottom and the charging unit 200 is incorporated into a bottom wall 112A of the storage area 114.

FIG. 2 is a schematic diagram of the electronic components of the charging unit 200, which has an external charging connector 202, a device charging connector 204, a switch 206, charging circuitry 208, and a rechargeable battery 210. The charger 100 is used to wirelessly recharge a battery in the cell phone PH. The battery charger 100 itself has to be recharged on occasion and this is done in the conventional manner by plugging it into an external power source. The external charging connector 202 is provided for this purpose and is adapted to receive a pin connector or port of a conventional corded charging device, which is then plugged into the standard household outlet or the automobile charger to recharge the battery 210. The switch 206 enables or interrupts current flow from the rechargeable battery 210 to the battery that is incorporated in the cell phone PH. The external charging connector 202 is readily accessible on the outside of one of the walls 112. The rechargeable battery 210, when fully charged, provides an additional 5 to 9 hours of phone use, before the user has to plug either the battery charger 100 or the cell phone PH into an external power source. The device charging connector 204 extends into the storage area 114 of the case from the wall 112, so as to couple with the charging port CP on the cell phone PH when the cell phone is held in the case 110. The charging unit 200 charges the cell phone PH only when the switch 206 is turned on, so the cell phone PH may be used while it is stored in the case 110 without depleting the rechargeable battery 210. Once the cell phone is charged, the switch is set to the OFF position, to conserve any remaining power left in the rechargeable battery 210. The rechargeable battery 210 is a battery typically used in the cell phone industry, such as a 6-volt rechargeable battery. It is understood that the battery may be any appropriate voltage typically used with electronic devices, particularly cell phones, and may be replaceable. Optionally, a status indicator light 212 may be provided on the charging unit 200 to indicate the status of the battery charger 100. For example, a flashing green light may indicate that the charging unit 200 is charging, a flashing red light may indicate that the rechargeable battery 210 needs to be charged, or a steady green light may indicate the battery charger 100 has sufficient charge for use. FIG. 2 illustrates an example of appropriate charging circuitry 208, but it is understood that any suitable circuitry used with electronic devices may be used

The case 110 is similar to a conventional cell phone or portable device holder or shell, such as one that clips onto a man's belt or one that is small enough to fit into a purse, and may be made of any material, such as leather or nylon.

It is understood that the embodiments described herein are merely illustrative of the present invention. Variations in the construction of the cell phone charger may be contemplated by one skilled in the art without limiting the intended scope of the invention herein disclosed and as defined by the following claims.

What is claimed is:

1. A device charger for charging a rechargeable battery incorporated into an electronic device, said device charger comprising:
a case having a case wall that defines a storage area, said storage area being adapted to receive said electronic device; and
a charging unit incorporated into said case wall, said charging unit having a charging unit battery that is rechargeable, a device-charging connector that projects from said case wall into said storage area, so as to couple with a charging connector on said electronic device, and an external charging connector for receiving a connector for coupling said charging unit battery to an external power source;
wherein said charging unit battery charges said rechargeable battery of said electronic device to provide additional operating time of said electronic device, without having to connect said electronic device into a corded charging device.

2. The device charger of claim 1, wherein said charging unit battery is replaceable.

3. The device charger of claim 1, said charging unit further comprising charging circuitry for charging said rechargeable battery of said electronic device.

4. The device charger of claim 1, said charging unit further comprising a status indicator light.
